(19) United States
(12) Patent Application Publication
(10) Pub. No.: US 2005/0108552 A1
(43) Pub. Date: May 19, 2005

(54) Security method and system

(76) Inventors: Boaz Simon Gelbord, Amsterdam (NL); Gerrit Roelofsen, Leiden (NL)

Correspondence Address: MICHAELSON AND WALLACE;PARKWAY 109 OFFICE CENTER, 328 NEWMAN SPRINGS RD, P O BOX 8489, RED BANK, NJ, 07701, US

(21) Appl. No.: 10/496,281

(22) PCT Filed: Nov. 4, 2002
(86) PCT No.: PCT/EP02/12353

(30) Foreign Application Priority Data
Nov. 23, 2001 (EP) 01204519.1
Nov. 27, 2001 (EP) 01204569.6

(51) Int. Cl. H04L 9/00; H04K 1/00

(52) U.S. Cl. 713/186

(57) ABSTRACT

Conversion of a biometric item e.g. a recorded fingerprint (FP) into a password (PW). The fingerprint is converted into a fingerprint representation (FPR) which is to be matched with a set of classes of fingerprint representations (FPC), stored in a database. The matching class is selected. Each class is, within the database, linked with one stored password (PW). The password which is linked with the selected class, is output to the relevant system (8) asking for the security password.

### FIELD OF THE INVENTION

The invention generally relates to access security in computer and telecommunication networks, data systems, etc., using security codes like PINs etc., or by means of biometric data like fingerprints, facial scans, retina scans, etc.

### BACKGROUND OF THE INVENTION

The use of biometric methods for the identification of persons is growing and so the number of biometric methods used for that purpose does. In particular there might be significant advantages in many applications, including automatic teller machines (ATM's), home banking and e-commerce applications, to replace alphanumerical security codes by biometric items, since a user's biometric characteristic is always available, while a numerical security code might be forgotten or be obtained by a third party.

Though the techniques for biometric identification have matured, there are some problems. A major problem is the unwillingness of people to provide their personal biometric data for identification purposes. One reason for this is that people fear that a receiver or verifier of biometric data might misuse it. The second reason is the negative feelings in general associated with providing personal biometric data.

### SUMMARY OF THE INVENTION

For entering a secured system, in most cases a not-secret user identifier (e.g. login name, account number) has to be entered (e.g. manually or by means of an ID card), to be followed by a secret security code (e.g. password, PIN code).

It is observed that in most cases there is no real need to have security codes which are absolutely unique over all other security codes. The uniqueness in fact is formed by the combination of each not-secret but certainly unique user identifier plus the secret but not pertinently unique security code.

One aspect of the present invention is to generate a security code for a user, entering a secure system or application, based on the users' (unique) biometric characteristics.

According to a further aspect of the invention, the security codes generated are certainly secret but need not to be absolutely unique for all users. This option prevents that each individual security code could be linked back to one individual person, which situation is inwanted. In such a way the privacy and psychological problems for the use of biometric identification could be taken away. Instead of linking back from the security code to one user, in this option only a link could be made from the relevant security code to a number of individual users, each of them applying the same security code, however in combination with different, unique user identifiers.

### BRIEF DESCRIPTION OF THE DRAWINGS

FIG. 1 shows schematicly the embodiment of a system which is fit for execution of the method as depicted above.

### DETAILED DESCRIPTION OF THE DRAWINGS

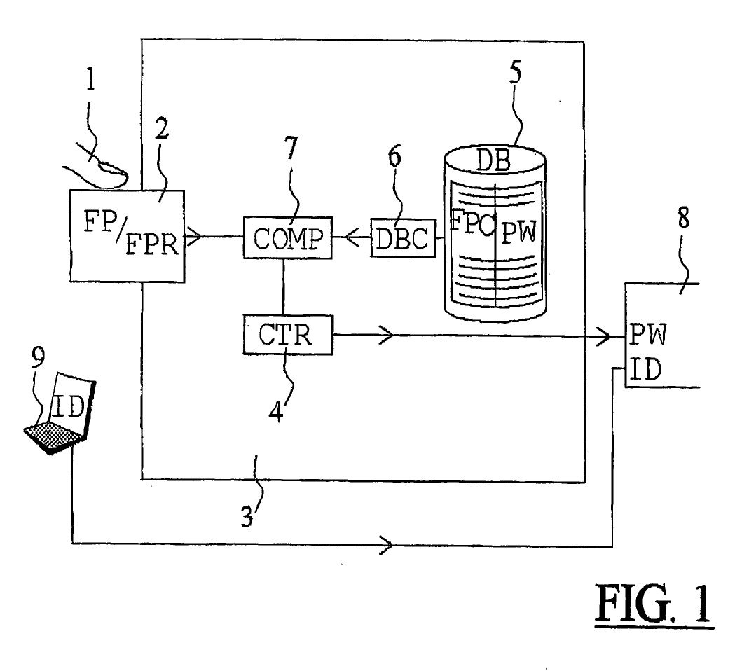

In FIG. 1 a user's finger 1 is brought into contact with a fingerprint recorder 2, in which the entered fingerprint (FP) is converted into an digitally processable fingerprint representation (FPR) which is entered into a module 3, fit for converting the fingerprint representation into a security code or “password” (PW), which might be entered in a e.g. computer system 8 having secure access facilities.

Firstly, the user may enter, via e.g. a data terminal, PC or card terminal 9, his/her user identifier (ID), which is input in system 8. Normally the ID is unique for the user or for a user group he/she belongs to, while normally the user ID is not-secret.

Module 3 serves for generating and outputting a secret security code or password after the user has input his/her user ID.

Module 3 comprises a control modul (CTR) 4, a database (DB) 5, a database controller (DBC) and a matching or comparing module (COMP) 7.

The database 5 contains a set of (e.g. 10,000) classes of fingerprint representations—having a format which is compatible (comparable, matchable) with the format of the input fingerprint representations (FPR)—comprising the whole scala of different fingerprints representations resulting from fingerprints originated by all kinds of users 1, via module 2. Each stored fingerprint representation class (FPCₓ) is linked to one stored security code (PWₓ). All security codes have to be secret.

After a fingerprint has been entered via module 2, under control of control module 4 the fingerprint representation, output by module 2, is compared (matched), by module 7, with all fingerprint representation classes stored in database 5. Module 7 matches the FPCs with the user's FPR using one of the matching algorithms which nowadays are in use in modern fingerprint recognizing systems.

After the matching module 7 finds one fingerprint representation class (FPC_{y}) which matches best with the entered fingerprint representation (FPR), the database controller outputs the security code (PW_{y}) which is linked to that matching fingerprint representation class (FPC_{y}), which security code (PW_{y}) is output to the secure access means of system 8.

It is noted that there are several methods for classifying en matching fingerprints, as discusse, for instance, in reference [1] in which fingerprints are classified—for sake of recognition—by way of a spatial re-sampling of each fingerprint pattern through concentric circles. The resulting circles are then correlated with those from a known set (comparable with the set stored in database 5) to obtain a collection of the most probable matches. This technique has shown good results when comparing other methods like binary test patterns or synthetic binary fingerprint images.

Further, it is noted that entering fingerprints in the embodiment of FIG. 1 only is an example of a biometric items which can be used for secure access purposes. Other examples are e.g. retina scanning, face scanning and other biometric data which are user specific. It is stressed that, although these biometric data generally are considered to be unique and therefor susceptible to fear of using, each biometric item will be converted, by module 3, into a not-unique, secret security code (PW), which forms, together with the entered user name, which has to be unique for the system 8, a unique and secure access couple.

Below, forming the set of fingerprint classes and the matching process is treated in a more mathematical approach. The following notations are used:

T denotes a set of 10,000 pre-defined (pseudo-) fingerprints.

F, G, and H denote three transformations, where F maps the set of all real fingerprints to the set S of all digital images of fingerprints,

G maps the set of all digital images of fingerprints to the set T of 10,000 pre-defined (pseudo-) fingerprints, and H maps the set T to the set of all 4-digits pins.

Let there be a metric M defined which defines a distance between any two fingerprints. We do not specify what M is, since there are numerous well-defined metrics that can be used. In one embodiment, M is the metric which measures the Cartesian distance between the n-tuples which measure a set of given fingerprint characteristics, where n is the number of characteristics.

The invention comprises a process of mapping a fingerprint to a given class of fingerprint. A small number of classes (e.g. 10,000) is meant to ensure that with very high probability the same given physical fingerprint will be mapped to the same pre-defined (pseudo-) fingerprint. Also we note that the set T shall be chosen in such a way so as to maximise the probability that F (an original fingerprint) is always (i.e. at the very time the original fingerprint is taken) mapped to the same pre-defined (pseudo-) fingerprint.

Note that a token may be used to contain all the 10000 pre-defined (pseudo-) fingerprints that comprise T.

The concatenation of the three functions, F, G, and H achieves the assignment of a 4 digit PIN to a real fingerprint. In particular F transforms a real fingerprint to a digital image. G transforms image to one of 10000 pre-defined (pseudo) fingerprints. H transform a pre-defined (pseudo-) fingerprint to a 4 digit PIN.

There are numerous ways to construct a function F. These are outside the scope of this document.

An example construction of G is as follows:

Let S be the set of all digital images of a real fingerprints.

Let us define for each digital image of a fingerprint in the set S a set of characteristics C_{—}1, . . . , C_n. These characteristics measure different values of a real fingerprint (e.g. distances and directions). Thus for a given S_{—}1 in S, once can construct the value C_i(S_{—}1) for any i from 1 to n, and this yields a real numeric value.

In such a way for each S_{—}1 in S, one can associate a real n-tuple C(S_{—}1), which is namely C(S_{—}1)=(C_{—}1(S_{—}1), C_{—}2(S_{—}1), . . . , C_n(S_{—}1)).

This in turn defines a distance between any two elements in S, namely:
distance(S_{—}1,S_{—}2)=Cartesian distance(C(S_{—}1), C(S_{—}2)).

Using this distance, we can define G(S_{—}1) to be that element in t in T for which distance (S_{—}1, t) is minimal.

We note that given two elements S_{—}1 and S_{—}2 derived from the same original finger, their distance from each other will be comparatively low (in relation to digital prints taken from other fingers). Due to the small size of T (10,000) relative to S, this will ensure that these two elements S_{—}1 and S_{—}2 will always be mapped to the same element in T, provided that T is chosen so that
prob(G(S_{—}1)≠G(S_{—}2))
is minimised, where S_{—}1 and S_{—}2 are two elements of S derived from the same actual finger. This means that the set T must be constructed in such away that all pairs (T_{—}1, T_{—}2) from T have a mutually high distance (i.e. the Cartesian distance (C(T_{—}1), C(T_{—}2)) should be large for all pairs (T_{—}1, T_{—}2) from T).

The set T can be chosen in numerous ways. E.g. methods from error correcting code theory could be applied. We note that the choice of T is also dependent on the choice of the G. The function H may be constructed in many ways. One of the methods is to define an ordering of the 10,000 (pseudo-) fingerprints T_{—}1, T_{—}2, T_{—}3, . . . , T_{—}10000 in T based on their Cartesian distance to a fixed value T_f from (so order (T_i)=Cartesian distance (C(T_i), C(T_f)). The PIN values 0000-9999 are then assigned to in the thus defined order. But the PIN values may also be assigned in a random way to the elements of T.

As presented up here, the invention comprises a process of mapping an entered fingerprint to a given class of fingerprint. A relative small number of classes (e.g. 10000) is preferred to ensure that with high probability always the same entered fingerprint will be mapped to the same equivalence class. Hereafter a preferred method is discussed to optimize the set of 10000 classes.

1. An initial, not-optimized set of classes T is made up, comprising classes T1, T2, . . . , T10000 respectively.

2. A sample set of fingerprint representations is obtained by taking a random sample of fingerprints entered by several users or by using a standards set commercially available. This sample set comprises e.g. 100 samples, denoted by S1, S2, . . . , S100.

3. A known, commercially available image recognition program may be used, comprising a known matching algorithm. The program's algorithm begins by searching for a match of S1 to one of the classes of set T. Once a match is found, the program continues with searching for a match of S2 to one of the classes T1 . . . T10000, after that with a search to a match of S3 to one the calsses etc. etc. In this way each of the samples S1 to S100 is matched to one class from the set of classes T.

4. The process under 3. is executed for a second set of fingerprint representations S1′, S2′, . . . , S100′. The process depicted under 3. is carried out: S1′, S2′, . . . , S100′ is matched, by the matching program with the set of fingerprint classes T resulting in each of the samples S′1 to S′100 being matched to one class from the set of classes T.

5. The process under 3. may be carried out another time or still more times.

6. At this stage the set T is assigned an evaluation value e.g. based on number of times that corresponding representations (S1-S1′-S1″- . . . , S2-S2′-S2″- . . . , etc.) lead to different matching classes, e.g. the corresponding fingerprint representations S2 and SS2″ match with class T32, while representation S2′ matches with class T33.

7. Subsequently one or more new class sets T′, T″, etc. are generated, preferrably by adaptation of the previous set of classes at those points where corresponding fingerprint representations lead to different matching results (e.g. classes T32/33, see up here) to which in the same way evaluation values are assigned; the set having the lowest value is deemed to be the wanted optimized set of classes.

### REFERENCE

1. David H. Chang, Fingerprint Recognition Through Circular Sampling, 1999 Center for Imaging Science Rochester Institute of Technology Rochester, N.Y. 14623-5604.

1. Method for access control to a system (8), comprising the steps of
a. entering a user's biometric item (FP);
b. selecting one class from a set of classes (FPC) which corresponds most closely to the user's biometric item;
c. deriving a security code (PW) from the selected class.

2. Method according to claim 1, comprising that each class is linked to one security code (PW).

3. Method according to claim 2, comprising that each security code (PW) is a previously generated, unique code, linked to one class.

4. Method according to claim 1, comprising that the biometric item is converted into a biometric representation of that item.

5. Method according to claim 4, comprising that the set of classes comprise representations which are comparable with the representation of the user's biometric item.

6. Method for an optimized set of classes (FPC) to be used for matching with biometric items, comprising the steps of
a. an initial set of classes is made up, comprising representations which are comparable with the representation of said biometric items;
b. a number of representation sample set are obtained, each comprising representations of biometric items from a biometric items sample set, each representation representing one biometric item, and each representation sample set comprising unique representations of the respective biometric items;
c. for each representation sample set, for each representation out of that set one class is selected from said set of classes, which class corresponds most closely to that representation;
d. an evaluation value is calculated based on the number of times that corresponding representations, viz. representations in different representation sample sets but representing the same biometric item, lead to different resp. equal class selections;
e. said initial set of classes is renewed one or more times, each time an evaluation value being assigned to it according to the previous steps, while the initial set of classes having the lowest evaluation value is selected as the wanted optimized set of classes.

7. Methode according to claim 6, comprising that said renewal of the set of classes is achieved by adaptation of the previous set of classes at those points where corresponding fingerprint representations lead to different matching results.

8. System for access control comprising means (2) for recording a user's biometric item (FP), means (7) for selecting, from a set of classes (FPC) stored in storing means (5), one class which corresponds most closely to the recorded biometric item, and means (5,6,7,4) for deriving a security code (PW) from the selected class and for outputting that security code.

9. System according to claim 8, comprising that each class, stored in the storing means (5) is linked to one security code (PW).
